(19) United States
(12) Patent Application Publication
(10) Pub. No.: US 2025/0062505 A1
(43) Pub. Date: Feb. 20, 2025

(54) TERMINAL ASSEMBLY FOR A SECONDARY CELL

(71) Applicant: NORTHVOLT AB, Stockholm (SE)

(72) Inventor: Michael KOMA, Västerås (SE)

(21) Appl. No.: 18/793,035

(22) Filed: Aug. 2, 2024

(30) Foreign Application Priority Data
Aug. 16, 2023 (SE) 2350970-6

(51) Int. Cl. H01M 50/559; H01M 10/058; H01M 50/107; H01M 50/169; H01M 50/567

(52) U.S. Cl. CPC H01M 50/559; H01M 10/058; H01M 50/107; H01M 50/169; H01M 50/567

(57) ABSTRACT

There is disclosed herein a terminal assembly for a cylindrical secondary cell comprising a hollow shaft having an axial through-hole, configured to extend axially through an opening in a casing of the secondary cell to electrically contact a current collecting plate of the secondary cell at a first end of the hollow shaft, and a cap arranged at a second end of the shaft, configured to close and seal the axial through-hole. There is further disclosed herein a cylindrical secondary cell comprising the terminFal assembly and a method of manufacturing the cylindrical secondary cell.

### BACKGROUND

### Related Field

The present disclosure relates to a terminal assembly for a secondary cell, a secondary cell comprising the terminal assembly, and a method of manufacturing such a secondary cell.

### Related Art

In addressing climate change, there is an increasing demand for rechargeable batteries, e.g. to enable electrification of transportation and to supplement renewable energy. Currently, lithium-ion batteries are becoming increasingly popular. They represent a type of rechargeable battery in which lithium ions move from the negative electrode to the positive electrode during discharge and back when charging.

As the demand for rechargeable batteries increases, more and more focus is being placed on production speed and cost. To achieve an effective production of rechargeable batteries, the design of the batteries as well as their manufacturing process can be optimized.

### BRIEF SUMMARY

The present disclosure aims to provide improved secondary cells and parts thereof. The improvements may be in energy performance, manufacturing efficiency, decreased amount of material used, and assembly simplification, among others.

In particular, according to an aspect of the present disclosure, there is provided a terminal assembly for a cylindrical secondary cell comprising a hollow shaft having an axial through-hole, configured to extend axially through an opening in a casing of the secondary cell such that a first end of the hollow shaft extends into the casing, and a cap arranged at a second end of the shaft, configured to close and seal the axial through-hole.

According to further aspects of the present disclosure, there is provided a cylindrical secondary cell comprising said terminal assembly, and a method of manufacturing said cylindrical secondary cell.

By providing the terminal assembly in multiple parts in this way, greater freedom for both the hollow shaft and the cap is provided, in respect of the dimensions or materials of the part, for example.

The hollow shaft may be deformed in some manner when arranged in the opening of the casing so as to retain the hollow shaft in position. Thereafter, the hollow shaft can serve as a conductive path from the electrode assembly (either directly or via a current collector) to the cap. Indeed, the hollow shaft, being hollow, may advantageously allow for the passage of a welding laser therethrough so as to attach the hollow shaft to a current collector or directly to an electrode assembly. The hollow shaft may further advantageously allow for the possibility of filling the secondary cell with electrolyte through the through-hole thereof, negating a requirement for a separate filling conduit in the casing of the cell or elsewhere.

The cap may serve as an external terminal for the cylindrical cell or may be configured to receive one or more further parts that act as the external terminal.

In any event, it can be appreciated that the terminal assembly, being formed as a hollow shaft and a cap sealing the hollow shaft, advantageously improves the manufacturing flexibility for a secondary cell.

In a preferred implementation of such a terminal assembly, the hollow shaft is formed as a rivet having an internal flange extending radially from the first end of the hollow shaft and/or an external flange extending radially from the second end of the hollow shaft.

That is, the hollow shaft may be deformed at one or both ends, as part of a riveting process, in a manner understood by those skilled in the art, so as to bend radially outwards away from the central axis of the shaft. Thereby, one or a pair of flanges can be formed that aids in retaining the hollow shaft in the opening of the casing.

In an example implementation of the present disclosure, an internal flange may already be integrally formed at the first end of the shaft, acting as an integrated current collecting part for abutting the electrode assembly or an additional current collector.

The secondary cell may be configured such that one of the terminals is formed as the entirety of the casing of the cell, or just an upper surface of the casing, where the terminal assembly is arranged, and then the terminal assembly serves as the other terminal (e.g., the cathode connection). Accordingly, it will be understood that the terminal assembly should be electrically insulated from the casing of the cell. Furthermore, secondary cells typically comprise liquid electrolyte, and thus the opening in the casing should preferably be closed in a water-tight manner. To this end, a gasket may be arranged around the hollow shaft of the terminal assembly to electrically insulate the terminal assembly from the casing and to form a water-tight seal between the terminal assembly and the casing.

In an example implementation of the present disclosure, the hollow shaft comprises both an internal flange and an external flange. In such an implementation, the gasket may have a part that extends between the internal flange and an inner surface of the casing, and a part that extends between the external flange and an outer surface of the casing, as well as a part therebetween that extends along the axis of the hollow shaft.

The presence of both the internal flange and the external flange advantageously allows for a more controlled and even compression of the gasket. The internal flange compresses the gasket against an internal corner of the opening in the casing, and the external flange compresses the gasket against an external corner of the opening in the casing. Preferably, the compression of the gasket at the internal corner of the opening in the casing is 1.5 to 2.5 times the compression of the gasket at the external corner of the opening in the casing, more preferably substantially double.

The cap may be welded directly to the second end of the hollow shaft or welded indirectly to the second end of the hollow shaft, e.g., via an external flange at the second end of the hollow shaft. The cap is preferably welded to the second end of the hollow shaft via laser welding, but may also be welded to the second end of the hollow shaft via resistance welding, ultrasonic welding, soldering, or other means that efficiently create a secure and electrically conductive attachment between the cap and the second end of the hollow shaft.

At the other end of the hollow shaft, i.e., the end that extends into the casing of the secondary cell, the hollow shaft may be connected to a current collector (which may be a disc, a plate, or have some other shape). Alternatively, the first end of the hollow shaft may have an integrally formed current collecting part.

A solid shaft may be inserted into the hollow shaft, wherein the solid shaft may be sized to substantially fill the through-hole of the hollow shaft. The solid shaft may be further attached to a current collector and/or the cap at respective first and second ends of the solid shaft. The solid shaft may be a single piece of metal, e.g., a same metal as the hollow shaft, and in preferred implementations, the solid shaft and the cap are formed as a single piece such that the solid shaft extends from a side of the cap that faces towards the hollow shaft.

The hollow shaft (and/or the solid shaft) may have a constant radius along its length, or may taper along its length so as to get wider from the first end (inside the casing) to the second end (outside the casing). The hollow shaft may, at some point along its length, have a radius exceeding the radius of the opening in the casing through which the hollow shaft extends. In this way, the hollow shaft may advantageously be prevented from passing all the way through the opening, and a preferred length of the hollow shaft extending into the casing can be configured.

When manufacturing a secondary cell having a terminal assembly according to the previously described aspect of the present disclosure, the method comprises arranging the hollow shaft of the terminal assembly through the opening in the casing, and attaching the cap to the second end of the hollow shaft.

Optionally, arranging the hollow shaft of the terminal assembly through the opening in the casing comprises screwing the hollow shaft into the opening of the casing. In such an example, an external surface of the hollow shaft may comprise threading or a ridged profile.

If the hollow shaft comprises an internal and/or external flange in a riveted state of the terminal assembly (i.e., where the terminal assembly comprises a terminal rivet), then the method may further comprise riveting the hollow shaft to thereby form the internal flange and/or the external flange. The riveting process can be carried out in a manner understood by those skilled in the art.

If the terminal assembly further comprises a solid shaft, then the method may further comprise attaching said solid shaft to a current collector, which may be separate to or collectively formed with the hollow shaft. The solid shaft may be attached by, e.g., ultrasonic or resistance welding, depending on the implementation.

### BRIEF DESCRIPTION OF THE FIGURES

One or more embodiments of the present disclosure will be described, by way of example only, and with reference to the following figures, in which:

FIGS. 1A to 1C schematically show various views of a hollow shaft of a terminal assembly according to aspects of the present disclosure;

FIG. 1D schematically shows a perspective view of a cap of a terminal assembly according to aspects of the present disclosure;

FIG. 1E schematically shows a perspective view of an assembled terminal assembly having the hollow shaft shown in FIGS. 1A to 1C and the cap shown in FIG. 1D;

FIG. 1F shows a cross-sectional view of an alternative version of the hollow shaft shown in FIGS. 1A to 1C, wherein the hollow shaft is tapered;

FIGS. 2A and 2B show a perspective and cross-sectional view, respectively, of a hollow shaft and a solid shaft partially inserted into the hollow shaft, according to an example implementation of the present disclosure;

FIG. 3 schematically shows a cross-sectional view of a terminal assembly according to an example implementation of the present disclosure, installed into an opening of a casing of a terminal cell;

FIG. 4 illustrates a method of manufacturing a secondary cell having a terminal assembly, according to aspects of the present disclosure;

FIGS. 5A to 5E schematically show across-sectional views depicting a progression of an installation of a terminal assembly according to an example implementation of the present disclosure into an opening of a casing of a secondary cell; and

FIG. 6 schematically shows a cross-sectional view of a cylindrical secondary cell having a terminal assembly according to aspects of the present disclosure.

### DETAILED DESCRIPTION

The present disclosure is described in the following by way of a number of illustrative examples. It will be appreciated that these examples are provided for illustration and explanation only and are not intended to be limiting on the scope of the present disclosure. Instead, the scope of the present disclosure is defined by the appended claims.

Furthermore, although embodiments be presented individually for the sake of focused discussion of particular features, it will be recognized that the present disclosure also encompasses combinations of the embodiments described herein.

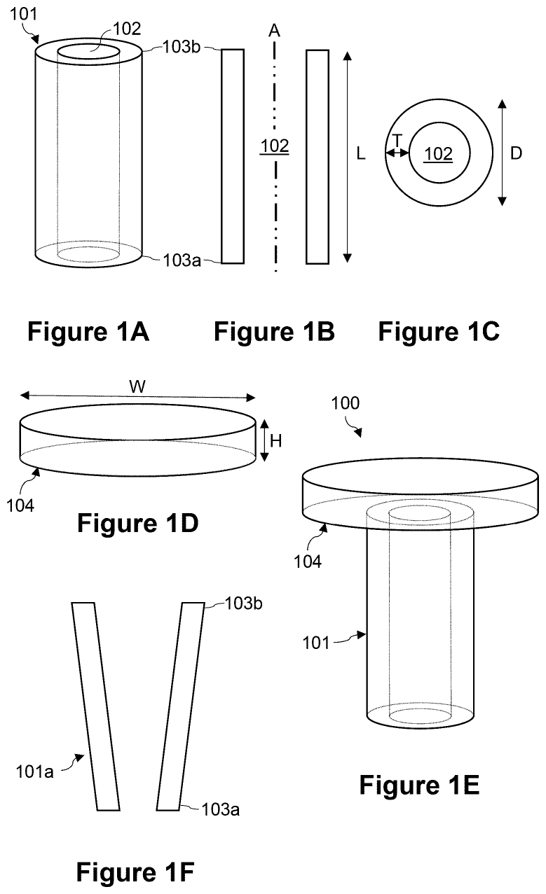

FIGS. 1A to 1C schematically show various views of a hollow shaft 101 of a terminal assembly according to aspects of the present disclosure. FIG. 1A shows a perspective view, FIG. 1B shows a cross-sectional view, and FIG. 1C shows a top view.

The hollow shaft 101 is cylindrical with a constant diameter D, wherein this results from the thickness T of the wall of the hollow shaft 101, as well as the radius of a through-hole 102 of the hollow shaft 101, being constant along its length L.

The hollow shaft 101 is preferably made from metal, such as aluminum. The hollow shaft 101 may be formed through extrusion methods known by those skilled in the art, or by casting or other techniques, the details of which are less relevant to the present disclosure.

FIG. 1D schematically shows a perspective view of a cap 104 of the terminal assembly. The cap 104, according to the illustrated example, is a cylinder having a diameter W greater than its height H. The diameter W of the cap 104 is shown as being configured to be substantially greater than the diameter of the opening of the casing into which the hollow shaft 101 will extend. However, in alternative embodiments, the cap 104 may have a same or smaller diameter W than the diameter D of the hollow shaft 101.

FIG. 1E shows the cap 104 from FIG. 1D arranged at an end of the hollow shaft 101 shown in FIGS. 1A to 1C, to thereby form a terminal assembly 100. The cap 104 is attached to the hollow shaft 101, preferably by welding, in particular resistance welding or laser welding. The attachment of the cap 104 to the hollow shaft 101 is preferably such that a water-tight seal is formed. In some examples, a recessed welding region may be provided on the cap 104 to facilitate the welding thereof to the hollow shaft 101.

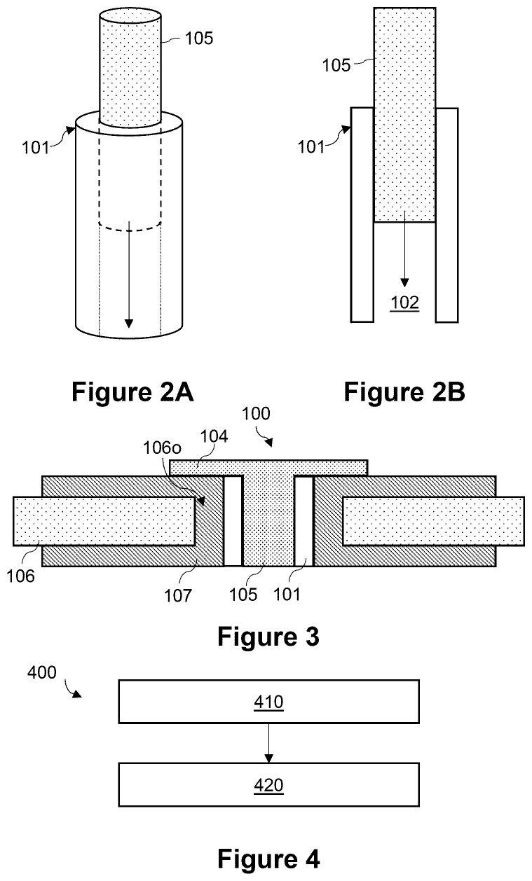

FIGS. 2A and 2B schematically show perspective and cross-sectional views, respectively, of a hollow shaft 101 of a terminal assembly (cap not shown), having a solid shaft 105 partially inserted into the through-hole 102 of the hollow shaft 101.

The solid shaft 105 is the same length as the hollow shaft 101 and has a diameter corresponding to that of the hollow shaft such that the solid shaft 105 substantially fills the hollow space in the hollow shaft 101. In other examples, the solid shaft 105 is longer or shorter than the hollow shaft 101 and may have a smaller diameter than that of the through-hole 102 of the hollow shaft 101.

The solid shaft 105 is made of metal, preferably the same metal as the hollow shaft 101 so as to ensure that the thermal behavior (e.g., swelling and shrinking) is the same as for the hollow shaft 101.

The solid shaft 105 may be attached to the hollow shaft 101, to the cap (not shown) and/or to a current collector, depending on the implementation. The solid shaft 105 may thus substantially increase the material mass of the assembled terminal assembly, thereby improving the electrical and thermal performance of the terminal assembly.

In some alternative examples, one or both ends of the solid shaft 105 may be tapered or have chamfered edges so as to aid in the centered insertion of the solid shaft 105 into the through-hole 102 of the hollow shaft 101.

FIG. 3 schematically shows an example implementation of a terminal assembly 100, comprising a hollow shaft 101, a cap 104, and a solid shaft arranged through the through-hole of the hollow shaft 101 so as to fill the hollow shaft 101, wherein the solid shaft 105 extends from the cap 104 as an integrally formed part thereof.

The terminal assembly 100 is arranged in an opening 1060 in a casing 106 of a secondary cell, only a part of which is shown in FIG. 3. Around the hollow shaft 101 and against the inside and outside surfaces of the casing 106, there is also provided a gasket 107.

The gasket 107 is configured to form a seal between the hollow shaft 101 and the opening 1060 of the casing 106. The gasket 107 may be made from any suitable material(s) than can provide electrical insulation and a water-tight seal, examples of such materials being known to those skilled in the art. As can be seen in FIG. 3, the hollow shaft 101 compresses the gasket against an internal and external corner of the opening 1060 in the casing 106 to thereby form said seal.

In such an example, the outer surface of the hollow shaft 101 may be threaded or ridged. The gasket 107 may be arranged in the opening 1060 of the casing 106 first, and the hollow shaft 101 may then be screwed or twisted into the opening 1060 to thereby engage or ‘bite’ the gasket 107 to form an effective water-tight seal for the opening 1060.

The cap 104 may be arranged against the hollow shaft 101 and attached thereto, preferably by welding such as resistance welding. The heat generated by the welding may be effectively dissipated by the material mass of the solid shaft 105 so as to mitigate damage to the gasket 107 or other surrounding parts (e.g., the tabs of the electrode assembly). The cap 104 may thus form a smooth electrical connection surface to act as an external terminal for the cell.

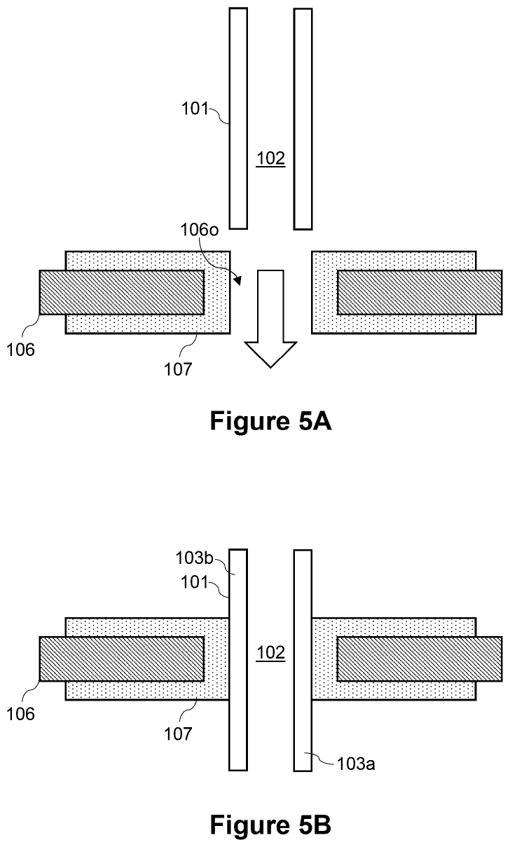

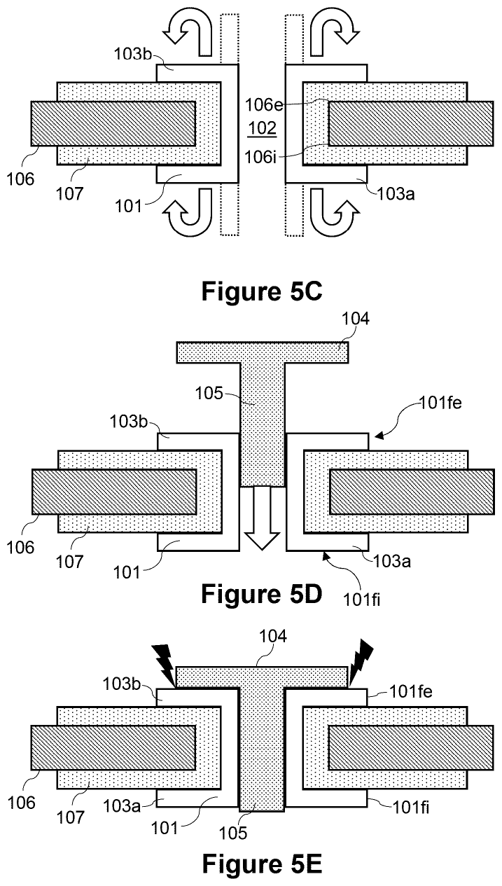

FIG. 4 illustrates a method 400 for manufacturing a secondary cell having a terminal assembly according to aspects of the present disclosure. A specific example of such a method is depicted in FIGS. 5A to 5E.

Generally speaking, a method 400 of manufacturing such a secondary cell comprises arranging 410 the hollow shaft of the terminal assembly through the opening in the casing, and attaching 420 the cap to the second end of the hollow shaft.

According to a more particular example shown in FIGS. 5A to 5E (starting with FIG. 5A), a casing 106 has a gasket 107 provided in an opening 1060 thereof, ready to receive a terminal assembly. It will be appreciated that, in other examples, the gasket may first be arranged around the hollow shaft 101, depending on, e.g., the form of the gasket 107 and/or the hollow shaft 101.

The hollow shaft 101 is then arranged through the opening 1060 (as shown in FIG. 5B). Unlike the arrangement shown in FIG. 3, the length of the hollow shaft 101 is substantially longer than the height of the casing 106 thickness and the gasket 107 combined, such that a first end 103a of the hollow shaft 101 extends substantially into the casing 106 and a second end 103b extends above the casing 106.

As shown in FIG. 5C, the first end 103a and the second end 103b of the hollow shaft 101 are riveted to thereby form an internal flange 101fi and an external flange 101fe, respectively. This riveting process compresses the gasket 107 against the casing 106. Specifically, the internal flange 101fi compresses the gasket 107 against an internal corner 106i of the opening 1060 in the casing 106, and the external flange 101fe compresses the gasket 107 against an external corner 106e of the opening 1060 in the casing 106.

To form a good seal, the compression of the gasket 107 at the internal corner 106i of the opening 1060 in the casing 106 is 1.5 to 2.5 times the compression of the gasket 107 at the external corner 106e of the opening 1060 in the casing 106, preferably substantially double (i.e., 2 times).

Once the flanges 101fi and 101fe have been formed, the cap 104 is added, which has an integrated solid shaft 105, as shown in FIG. 5D. The cap 104 is then welded at a periphery thereof to the external flange 101fe of the hollow shaft 101, as shown in FIG. 5E.

The internal flange 101fi and/or the solid shaft 105 may be welded to a current collector as a further or interceding step of the aforementioned method.

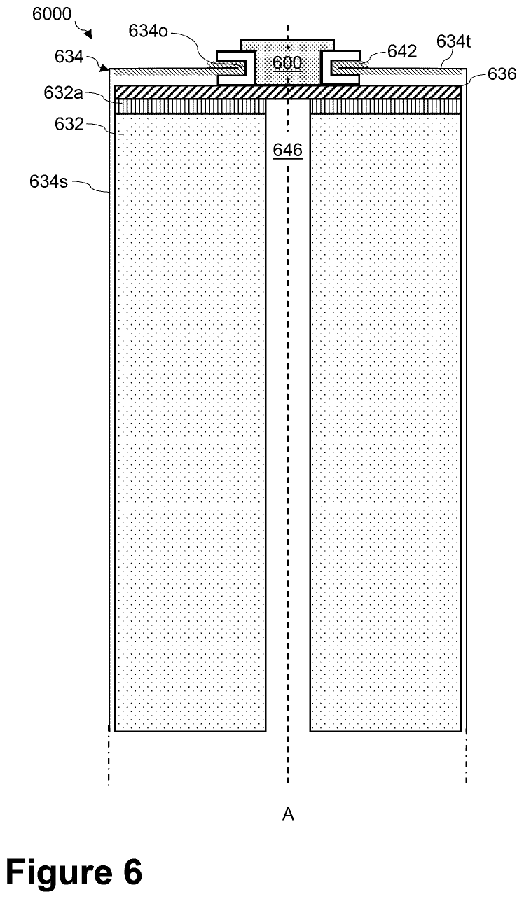

FIG. 6 schematically shows a cross-sectional view of a cylindrical secondary cell 6000 comprising a terminal assembly formed as a rivet 600 extending through an opening 6340 in the casing 634, corresponding to the example terminal assembly 100 shown and discussed in relation to e.g. FIG. 3. The particulars of the rivet 600 are thus not discussed again in relation to FIG. 6.

The cylindrical secondary cell 6000 (also referred to as simply the ‘cell 6000’) comprises an electrode roll 632 housed in a cylindrical casing 634. The electrode roll 632 may be formed of an anode sheet, a cathode sheet, and a separator sheet arranged therebetween to thereby enable a storage of electrical energy. Cathode tabs 632a may extend from a first end of the electrode roll 632 and anode tabs (not shown) may extend from the other end, or vice versa. The cathode tabs 632a and anode tabs may provide connective surfaces to which current collecting plates 636 can be connected.

The cylindrical casing 634 extends along an axis A between a first end 634t, which may be referred to as a ‘top end 634t’, and a bottom end (not shown) which may be an open end of the casing 634 closed by a lid. The closure of the casing may comprise a clamped closure or a welded closure, depending on the implementation.

For example, the casing 634 may further comprise a beading groove (not shown) formed in the side wall 634s. Hence, between the beading groove and the end edge of the side wall towards the bottom end of the casing, a clamping portion can be formed. A lid gasket may then be clamped around the bottom lid in the clamping portion to thereby seal the open bottom end of the casing. Providing a clamped closure in this way is well known in the art and thus can provide a reliable waterproof seal for the cell.

As another example, the lid may be welded to the casing to thereby seal the casing. The lid may be additionally welded to a current collector, or the lid may act as a current collector itself and be attached (e.g., welded) to the tabs of the electrode assembly 632. Providing a welded closure in this way may advantageously remove the number of components of the cell and/or the number of process steps required to manufacture the cell.

A cathode current collecting plate 636 is arranged in direct electrical contact with the cathode tabs 632a and an anode current collecting plate (not shown) may be arranged in direct electrical contact with the anode tabs (also not shown). Here, the labels ‘cathode’ and ‘anode’ may be swapped. Thus, an electrical connection is formed from the cathode tabs 632a to the terminal assembly, as the terminal assembly is connected to the current collecting plate 636.

An electrical connection may also formed from the anode tabs to the casing 634, either directly or through connection of an anode current collecting plate to the casing 634, e.g. in the clamping portion or by welding. One or both or the current collectors may be formed as a disc, a plate, or have some other shape.

At either end of the cell, the cell may further comprise a vent for venting gases, for example during a failure of the cell. Moreover, the cell may comprise an additional through-hole, in the casing and/or the lid, for filling the cell with a liquid electrolyte. This through-hole is preferably adapted to be closed from the outside, such as through the use of a blind rivet.

Thus, it is seen that the cap of the terminal assembly 600 serves as an external terminal of the cell 6000, this being a positive terminal in this example, and the casing 634 serves as the negative terminal. Hence, it is seen that both terminals of the cell 6000 are accessible at the same side. The top end 634t of the casing 634 comprises a first electrical contact surface extending in a first plane, and the head of the rivet 600 comprises a second electrical contact surface, extending in a second plane axially spaced from the first plane.

In an example, the current collector 636 is integrally formed as the internal flange of the hollow shaft of the terminal assembly 600. Alternatively, the internal flange and/or the solid shaft of the terminal assembly 600 is welded to the current collector 636.

Arranged around the terminal assembly 600 is a gasket 642 configured to form a fluid-tight seal for the opening 6340 in the top end 634t of the casing 634. The gasket 642 is arranged at least around the hollow shaft of the terminal assembly 600. The gasket 642 further extends between the head of the rivet 600 and the top end 634t of the casing 634 so as to electrically isolate the opposite terminals of the cell 6000 from each other. Thus, it can be seen that gasket 642 serves multiple purposes. The gasket 642 may be preferably formed of a polymer having elastic, resilient, and electrically insulating properties, such as PFA. In preferred examples, including that illustrated in FIG. 6, the gasket 642 extends between the cap of the terminal assembly 600 and the casing 634, radially beyond the cap of the terminal assembly 600.

In some examples, the gasket 642 may be formed of separate parts, each part being specifically configured for a respective purpose. For example, for the part(s) of the gasket 642 around the opening 6340 and intended to seal the opening, the gasket 642 may be formed of one material such as PFA. For the part(s) of the gasket 642 between the head of the rivet 600 and the casing 634 and intended to electrically isolate these components from each other, the gasket 642 may be formed from another material such as a PPS polymer.

The advantageous inclusion and configuration of the solid shaft of the terminal assembly 600 provides a greater material mass to the terminal assembly 600, thus aiding in dissipating heat throughout the terminal assembly 600, e.g., from welding or Ohmic heating. Hence, there is a reduced risk that the gasket 642 and/or the cathode tabs 632a are damaged by an excessively heated terminal assembly 600.

While the present disclosure is susceptible to various modifications and alternative forms, specific embodiments are shown and described above by way of example in relation to the drawings, with a view to clearly explaining the various advantageous aspects of the present disclosure. It should be understood, however, that the detailed description herein and the drawings attached hereto are not intended to limit the disclosure to the particular form disclosed. Rather, the intention is to cover all modifications, equivalents, and alternatives falling within the scope of the following claims.

1-13. (canceled)

14. A terminal assembly (100) for a cylindrical secondary cell comprising:
a hollow shaft (101) having an axial through-hole (102), configured to extend axially through an opening (1060) in a casing (106) of the secondary cell such that a first end (103a) of the hollow shaft extends into the casing, wherein the first end of the hollow shaft is welded to a current collector or wherein the first end of the hollow shaft comprises an integrally formed current collecting part; and
a cap (104) welded to a second end (103b) of the shaft, configured to close and seal the axial through-hole.

15. The terminal assembly according to claim 14, wherein the hollow shaft is formed as a rivet having an internal flange (101fi) extending radially from the first end of the hollow shaft and/or an external flange (101fe) extending radially from the second end of the hollow shaft.

16. The terminal assembly according to claim 15, further comprising a gasket (107) arranged around the hollow shaft and configured to form a seal between the hollow shaft and the opening of the casing;
wherein the internal flange compresses the gasket against an internal corner (106i) of the opening in the casing, and the external flange compresses the gasket against an external corner (106e) of the opening in the casing; and
wherein the compression of the gasket at the internal corner of the opening in the casing is 1.5 to 2.5 times the compression of the gasket at the external corner of the opening in the casing, preferably substantially double.

17. The terminal assembly according to claim 16, wherein the compression of the gasket at the internal corner of the opening in the casing is substantially double the compression of the gasket at the external corner of the opening in the casing.

18. The terminal assembly according to claim 14, wherein the cap is welded to the second end of the hollow shaft via resistance welding.

19. The terminal assembly according to claim 14, further comprising a solid shaft (105) arranged to extend through the through-hole of the hollow shaft.

20. The terminal assembly according to claim 19, wherein the solid shaft and the cap are formed as a single piece.

21. The terminal assembly according to claim 14, wherein the hollow shaft tapers along its length, from the second end to the first end.

22. The terminal assembly according to claim 14, wherein the current collecting plate and the hollow shaft are formed as a single piece.

23. A cylindrical secondary cell (6000), comprising:
a casing (634) having an opening therein; and
the terminal assembly (100) according to claim 14,
wherein the hollow shaft of the terminal assembly extends through the opening of the casing.

24. A method (400) of manufacturing the cylindrical secondary cell of claim 23, comprising:
arranging (410) the hollow shaft of the terminal assembly through the opening in the casing; and
attaching (420) the cap to the second end of the hollow shaft.

25. The method according to claim 24, wherein arranging the hollow shaft of the terminal assembly through the opening in the casing comprises screwing the hollow shaft into the opening of the casing.

26. The method according to claim 24, wherein, when the hollow shaft is formed as a rivet having an internal flange extending radially from the first end of the hollow shaft and/or an external flange extending radially from the second end of the hollow shaft, the method further comprises riveting the hollow shaft to thereby form the internal flange and/or the external flange.

27. The method according to claim 23, wherein, when the terminal assembly further comprises a solid shaft arranged to extend through the through-hole of the hollow shaft, the method further comprises attaching the solid shaft to a current collector.
